(19) United States
(12) Patent Application Publication
(10) Pub. No.: US 2008/0172386 A1
(43) Pub. Date: Jul. 17, 2008

(54) Automated dental identification system

(76) Inventors: Hany H. Ammar, Morgantown, WV (US); Diaa Eldin Mohamed Nassar, Dokki (EG); Eyad Haj Said, Jamestown, NC (US); Ayman Abaza, Morgantown, WV (US)

Correspondence Address: WEST VIRGINIA UNIVERSITY RESEARCH CORPORATION, 886 CHESTNUT RIDGE ROAD, P.O. BOX 6224, MORGANTOWN, WV, 26506-6224, US

(21) Appl. No.: 12/009,210

(22) Filed: Jan. 17, 2008

Related U.S. Application Data
(60) Provisional application No. 60/880,894, filed on Jan. 17, 2007.

(51) Int. Cl. G06F 17/30

(52) U.S. Cl. 707/6; 707/E17.014

(57) ABSTRACT

The ADIS can be an automated identification system comprised of a search and retrieval stage based on potential similarities and a verification stage to match based upon the comparisons of dental images. A first embodiment is an automated dental identification system comprising establishing and enhancing raw subject dental records and extracting high level features; establishing data communication between a client coupled to a server via a network; searching a dental records database via said data communication and creating a candidate list; comparing a subject dental record to the candidate list to categorize potential matches; and inspecting potential matches for a final determination. A further embodiment can be establishing and enhancing raw subject dental records further comprising record preprocessing wherein said record preprocessing comprises record cropping, film enhancement, film type detection, teeth segmentation, and teeth labeling. Another embodiment is searching dental records and creating a candidate list further comprising potential matches searching wherein said potential matches search comprises high-level feature extraction, archiving, and retrieval. Yet another embodiment of the invention can be comparing subject dental records to the candidate list further comprises teeth alignment, low-level feature extraction, and decision making.

### CROSS-REFERENCE TO RELATED APPLICATIONS

This application claims priority to Provisional Patent Application numbered U.S. 60/880,894.

### STATEMENT REGARDING FEDERALLY SPONSORED RESEARCH OR DEVELOPMENT

This invention was made with government support under Grant Nos. EIA-0131079 from the National Science Foundation and 2001-RC-CX-K003 awarded by NIJ. This invention was made with Government support under grants awarded by the NSF and NIJ. The Government has certain rights in the invention.

### REFERENCE TO SEQUENCE LISTING, A TABLE, OR A COMPUTER PROGRAM LISTING COMPACT DISC APPENDIX

Not Applicable

### BACKGROUND OF THE INVENTION

Post-mortem (PM) identification or identification after death is a more difficult problem than ante-mortem (AM) identification since few biometrics can be utilized. PM identification is carried out using either positive or presumptive identification methods. Presumptive methods include identification based on “visual recognition, personal effects, serology, anthropometric data, and medical history” (1). Positive identification methods involve comparison of ante-mortem and postmortem data that are unique to the individual. Positive PM Identification methods include: “(i) Dental comparisons, (ii) comparisons of fingerprints, palm prints, or footprints, (iii) DNA identification, and (iv) Radiographic superimposition”. Presumptive identification predominantly provides means for exclusion of potential mismatches based on race, gender, age, and blood type (1).

Under severe circumstances, such as those encountered in high energy mass disasters or if identification is being attempted more than a couple of weeks after death, most physiological biometrics do not qualify as a bases for identification. Under such circumstances the soft tissues of the human body would have decayed to unidentifiable status. Therefore, a PM biometric identifier must outlive the early decay that affects soft body tissues (1) (2). Because of their survivability, diversity and availability the best candidates for biometric PM identification are dental features. Forensic Odontology is the branch of forensics that studies identification of human individuals based on their dental features. Forensic Odontology utilizes three major areas to match PM identification with AM records: “(i) diagnostic and therapeutic examination of injuries of jaws, teeth, and soft oral tissues, (ii) identification of individuals in criminal investigations and mass disasters, and (iii) identification and examination of bite marks (1).

In PM identification, forensic odontologists rely mainly on dental radiographs. Other types of records utilized are oral photographs, denture models, and CAT scans. The forensic odontologist compares the morphology of dental restorations such as fillings and crowns of the unidentified persons to those of candidates in the missing persons file. With the significant improvement in the dental hygiene of the contemporary generations and the deployment of some materials with radiolucent properties in the fillings and restorations it is becoming important to shift to identification decisions based upon inherent dental features (1)-(4). These features include root and crown morphologies, teeth sizes, rotations, inter-teeth spacing and sinus patterns.

Manual radiograph comparison is a highly time-consuming process that requires high levels of skill and accuracy. With the increased volumes of both dental records and victims the task of the forensic odontologists becomes tedious, more difficult, and more time consuming. Hence, computer-aided dental record comparison systems become the proper means for manipulating large volumes of data while maintaining accuracy, consistency, and low running cost (1)(5).

There have been several attempts to develop computer-aided postmortem identification systems. The most well known of these systems, are the Computer Assisted Post Mortem Identification (CAPMI) and WinID® (5)(6). However, the existing systems provide merely a small amount of automation and require a significant amount of human intervention. For example, in both CAPMI and WinID® dental feature extraction, coding, and image comparison are performed manually. Moreover, the dental codes used in these systems are entirely based on characteristics of the dental work and not the inherent dental features (5)(6).

CAPMI is computer software that compares between dental codes, which are manually extracted from AM and PM dental records, and generates a prioritized list of candidates based on the number of matching dental characteristics. This list guides the forensic odontologists to reference records that have potential similarity with subject records and the odontologist completes the identification procedure by visual comparison of radiographs (5).

WinID® is computer software that matches missing persons to unidentified persons using dental and anthropometric characteristics to rank possible matches. Other information on physical appearances, pathological findings and anthropologic findings can also be added to the databases. The dental codes used in WinID® are extensions of those used in CAPMI.

However, none of these systems provide the desired level of automation, as they require a significant amount of human intervention. For example, in both CAPMI and WinID® feature extraction, coding, and image comparison are carried-out manually. Moreover, the dental codes used in these systems are entirely based on dental work. Hence, CAPMI and WinID® are more like sorting tools that help to cut down the time of forensic experts, but not identification systems.

While forensic odontologists rely on teeth orientation, type of restorative materials, and radiographic appearance as basis for positive identification. These properties are neither incorporated in CAPMI nor in WinID® as historically “testing has shown that incorporation of these additional data would only increase processing time while decreasing the power of the system due to mismatches induced by the subjectivity inherent in the recognition and identification of these entities” (7). Thus, the amount of automation offered by these dental identification systems resembles that of an automated fingerprint identification system, whereby a forensic expert is required to identify and classify the minutiae points of fingerprints before the system can produce a list of candidate matches to the subject.

### REFERENCES

1. P. Stimson & C. Mertz, Forensic Dentistry, CRC Press 1997.

2. American Society of Forensic Odontology, Forensic Odontology News, vol. 16, no. 2, Summer 1997.

3. D. F. MacLean, S. L. Kogon, and L. W. Stitt, “Validation of Dental Radiographs for Human Identification,” Journal of Forensic Sciences, JFSCA, vol. 39, no. 5, September 1994, pp. 1195-1200.

4. The Canadian Dental Association, Communique, May/June 1997.

5. United States Army Institute of Dental Research Walter Reed Arm Medical Center, “Computer Assisted Post Mortem Identification via Dental and other Characteristics”, USAIDR Information Bulletin, vol. 5, no. 1, Autumn 1990.

6. James McGivney, WinID3® software http://www.winid.com.

7. L. Lorton, M. Rethman, and R. Friedman, “The Computer-Assisted Postmortem Identification (CAPMI) System: A Computer-Based Identification Program,” Journal of Forensic Sciences, vol. 33, no. 4, July 1988, pp. 977-984.

### BRIEF SUMMARY OF THE INVENTION

The Automated Dental Identification System (ADIS) is a computer-implemented method to automat the process of post-mortem (PM) identification, containing the ability to search subject dental records from the Digital Image Repository (DIR) to find a minimum set of candidate records that have high similarities to the subject based on image comparison.

The ADIS can be an automated identification system comprised of a search and retrieval stage based on potential similarities and a verification stage to match based upon the comparisons of dental images.

A first embodiment can be an automated dental identification system comprising establishing and enhancing raw subject dental records and extracting high level features; establishing data communication between a client coupled to a server via a network; searching a dental records database via said data communication and creating a candidate list; comparing a subject dental record to the candidate list to categorize potential matches.

A further embodiment can be establishing and enhancing raw subject dental records further comprising record preprocessing wherein said record preprocessing comprises record cropping, enhancement, film type detection, teeth segmentation, and teeth labeling.

Another embodiment is searching dental records and creating a candidate list further comprising potential matches searching wherein said potential matches search comprises high-level feature extraction, archiving, and retrieval.

Yet another embodiment of the invention can be comparing subject dental records to the candidate list further comprises teeth alignment, low-level feature extraction, and decision making.

### BRIEF DESCRIPTION OF THE SEVERAL VIEWS OF THE DRAWING

These drawing are for illustrative purposes only and are not drawn to scale.

FIG. 1 is a block diagram of the prototype ADIS.

FIG. 2 is a block diagram of the three-stage approach for dental record cropping

FIG. 3 is a block diagram of the teeth segmentation method

FIG. 4 is a block diagram of the teeth labeling approach

FIG. 5 is a block diagram of the image comparison component

### DETAILED DESCRIPTION OF THE INVENTION

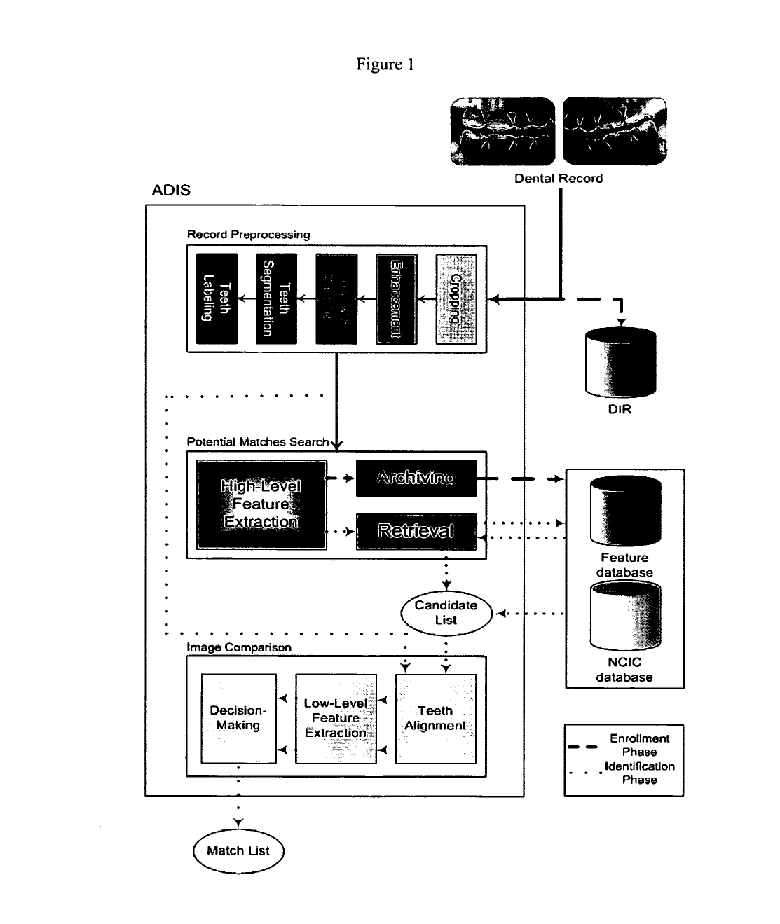

A first embodiment can be an automated dental identification system comprising establishing and enhancing raw subject dental records and extracting high level features; establishing data communication between a client coupled to a server via a network; searching a dental records database via said data communication and creating a candidate list; comparing a subject dental record to the candidate list to categorize potential matches; and inspecting potential matches for a final determination. The establishing and enhancing of raw subject dental records and extracting high level features can be accomplished by an Automated Identification System (ADIS) FIG. 1, which is a highly automated system comprised of the two stages of (1) search and retrieval stage based on potential similarities and (2) verification stage for matching based on low level comparison of dental images. The overall hierarchy of nomenclature in this application is that stage or component is the largest group. The stage is made up of steps, which are made up of sub-steps, which may be made up of phases. Phases include sub-phases within them as well. When fed with raw subject dental records the database such as the National Dental Image Repository (NDIR) or a database uploaded for a specific event such as a plane crash can find a minimum set of candidate records from the database that have high similarities to the subject. Then, a forensic expert can examine the radiographs of those few candidates to make a final decision on the identity of the missing or unidentified person. The DIR contains dental images of patients and is linked to the National Crime Information Center (NCIC) Missing and Unidentified Persons (MUP) files, which contain non-image information such as age, gender, race, and blood type. This information can be used to exclude candidates with impossible matches thus reducing the search space. The philosophy behind architecting the ADIS is that the search and retrieval step is a fast, high-recall system while the verification component is a high-precision matching system.

At a high level of abstraction, the ADIS can be viewed as a collection of the following mega-components: (i) The Record Preprocessing component handles dental records cropping into dental films, grayscale contrast enhancement of films, classification of films into bitewing, periapical, or panoramic views, segmentation of teeth from films, and annotating teeth with labels corresponding their location, (ii) The Potential Matches Search component manages archiving and retrieval of dental records based on high-level dental features (e.g. number of teeth and their shape properties) and produces a candidate list, and (iii) The Image Comparison component mounts for low-level tooth-to-tooth comparison between subject teeth—after alignment—and the corresponding teeth of each candidate, thus producing a short match list. Number (i) and (ii) would be within the search and retrieval stage while (iii) is in the verification stage.

Establishing and enhancing raw subject dental records and extracting high level features can also be labeled as preprocessing. The preprocessing step can be further comprised of the sub-steps of record cropping (global segmentation), dental film gray contrast enhancement, film type detection, teeth (local) segmentation, and automatic classification and labeling of teeth. Preprocessing can be made automatic by implementing any one of a number of programming languages such as, for example, Matlab, C++, or other programming languages.

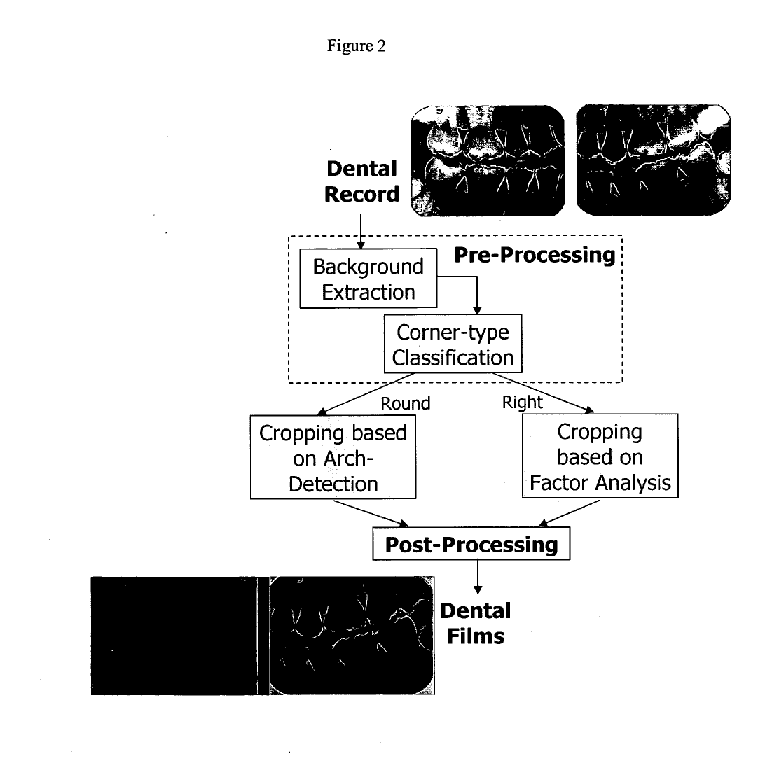

The digitized dental X-ray record of a person which often consists of multiple films can be cropped. This cropping sub-step can be viewed as a global segmentation problem of cropping a composite digitized dental record into its constituent films. There can be three phases within the dental record cropping sub-step as shown in FIG. 2. First phase is an extraction of the background layer of the image (dental record) then the connected components are classified as either round-corner or right-corner connected components. In the second cropping phase, an arch detection method is applied to round-corner components and dimension analysis is performed with right-corner components. The final cropping phase is a post processing phase where a topological assessment of the cropping results is performed in order to eliminate spurious objects, and to have cropped records (Films). Cropping is the segmentation of individual dental films from given dental records. Among the many challenges faced are non-standard assortments of films into records, variability in record digitization as well as randomness of record background both in intensity and texture. A three phase approach for record cropping based on concepts of mathematical morphology and shape analysis has been applied. In the first phase, the background layer of the image is extracted. An approach that counts on geometric clues such as the rectangular shape of dental films is used. Suppose the histogram of input image (dental record) is X (i, j) and the largest three peaks are n₁, n₂, n₃. Consider their corresponding level sets a ∂Lₖ, k=n₁-n₃ and apply morphological filtering to extract the boundary of those three sets Lₖ. Specifically, extract vertical and horizontal lines from ∂Lₖ by direct run-length counting and define the fitting ratio by:

rₖ=^{^{|R}}^{K}^{^{|}}/_{∂L}_{ₖ}, k=n₁, n₂, n₃

Where Rₖ is the binary image recording the extracted vertical and horizontal lines. The set with the largest fitting ratio among the three level sets is declared to be the background L_{b}. As soon as background is detected, there is no need to intensity information but only the geometry of L_{b} for corner type detection.

The complement of detected background _̅{̅L̅}̅_̅{̅_̅{̅b̅}̅}̅ consists of non-cropped dental films as well as various noises. The noise could locate in the background (e.g., textual information such as the date) or within dental films (e.g., dental fillings that have similar color to the background). To eliminate those noises, apply morphological area-open operator to L̅_̅{̅_̅{̅b̅}̅}̅ and L_{b} sequentially and to label the N connected components in L̅_̅{̅b̅}̅ by integers 1-N. For each connected component (a binary map), classify its corner type since a record could contain mixture of round-corner and right-corner films. The striking feature of a round-corner film is the arc segments around the four corners. In the continuous space, those arc segments are essentially 90°-turning curves (they link a vertical line to a horizontal one). In the discrete space, use a Hit-or-Miss operator to detect corner pixels first and then morphological area-close operator to locate arc segments.

In the second phase, for round-corner component, two types of V-corners associated with arc segments are sufficient for cropping. For 90° V-corner, its straight edge indicates where the cropping should occur. For 180° V-corner, note that it is symmetric with respect to the target cropping line. Therefore, the cropping of round-corner films can be fully based on locating and classifying the two types of V-corners. While for right-corner component, the cropping is based on the following intuitive observation with the boundary films. Due to the special location of boundary films, they can be properly cropped out with a higher confidence than the rest. Moreover, cropping out boundary films could make other non-boundary films become boundary ones and therefore the whole process of cropping boundary films can be recursively performed until only one film is left.

In the final phase, the post processing stage, prior information about dental films has shown that they are all convex sets, regardless of the corner-type. Such knowledge implies that the hole or cracks of any segmented component be filled in by finding its convex hull. Therefore, the first sub-phase in post-processing is to enforce the convexity of all connected components after cropping. Secondly, we check the size and shape of each convex component, to eliminate non-film object and put it back to the background layer.

During dental film gray contrast enhancement, a contrast-stretching step can be applied using a parametric sigmoid transform, to improve the performance of teeth segmentation. Film type detection is an important sub-step in ADIS preprocessing, as using the appropriate teeth segmentation algorithm and its parameters depends on the type of film. The main types of dental radiograph films considered in ADIS are: bitewing upper periapical and lower periapical films. The approach for film type detection is based on Principal Component Analysis. Six image subspaces are established corresponding to the top and bottom zones of a dental film. Three of these image subspaces correspond to the possible top zones of a dental film (Upper jaw (bitewing), Upper root (upper periapical), and Lower crown (lower periapical)). The other three image subspaces correspond to the possible lower zones of a dental film (Lower jaw (bitewing), Upper crown (upper periapical), and Lower root (lower periapical)).

For a given a dental film, each of its top and bottom zones are projected onto the corresponding subspaces in order to classify the dental film as follows:

A) The upper half of the dental film fᵤ is projected onto upper jaw bitewing, upper root periapical, and lower crown periapical image subspaces in order to get the respective weights ω_{ub}, ωᵤᵣₚ, ω_{ucp},

B) The lower half of the dental film fₗ is projected onto lower jaw bitewing, upper crown periapical, and lower root periapical image subspaces in order to get the respective weights ω_{lb}, ω_{lcp}, ωₗᵣₚ.

C) Each half of the dental film are reconstructed from the sample mean and the calculated weights from the previous subphases in order to obtain the approximations F_{ub}, Fᵤᵣₚ, F_{ucp}, and F_{lb}, F_{lcp}, Fₗᵣₚ respectively.

D) The upper half of the dental film is classified into one of the three classes (Upper jaw bitewing, Upper root periapical, and Lower crown periapical) based on the least energy discrepancy between that half and its approximations F_{ub}, Fᵤᵣₚ, F_{lcp}.

E) The lower half of the dental film is classified into one of the three classes (Lower jaw bitewing, Upper crown periapical, and Lower root periapical) based on the least energy discrepancy between that half and its approximations F_{lb}, F_{ucp}, Fₗᵣₚ.

F) If the upper or lower half of the dental film is classified as upper or lower jaw bitewing, then the film is classified as bitewing view. Otherwise, it is classified as periapical.

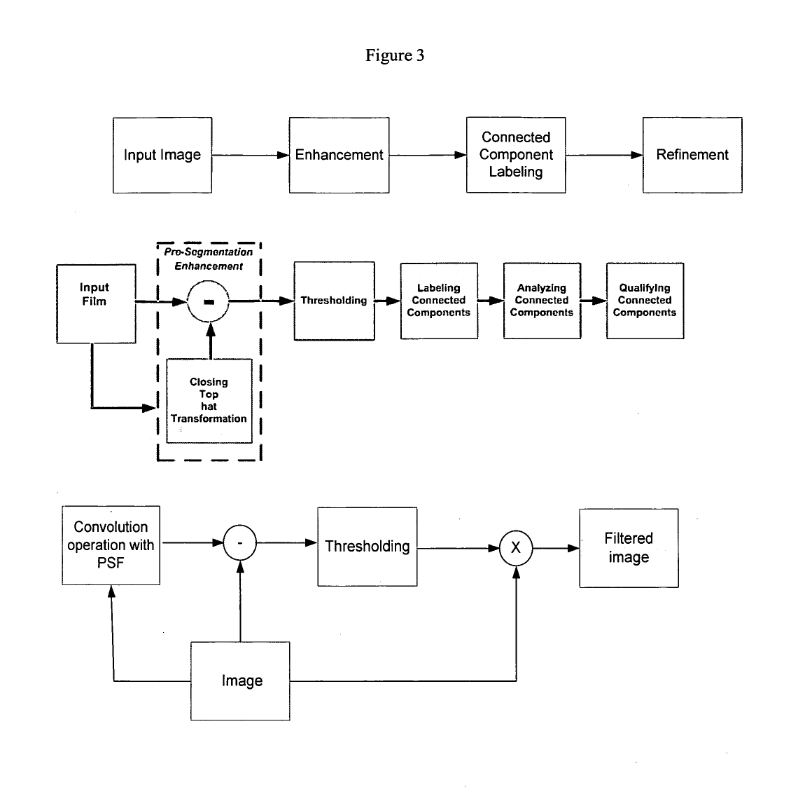

Teeth regions can be segmented from films. This segmentation can be viewed as local segmentation as in FIG. 3. Teeth segmentation can be an essential sub-step for extracting the teeth regions from the dental film. The segments can be used in the later subsequent aspects of the identification process. Automated teeth segmentation is an essential sub-step in the identification process with goal to extract at least one tooth from the dental radiograph film. Three main classes of objects in the dental radiograph images have been identified, teeth that map to the areas with “mostly bright” gray scales, bones that map to areas with “mid-range” gray scales, and background that maps to “dark” gray scales. The segmentation algorithm consists of three main phases: a) enhancement, b) connected components labeling, and c) refinement.

In an enhancement phase, the teeth can be emphasized while other objects in the dental image suppressed by using sequence of convolution filtering operations based on point spread function and then applying global thresholding to extract the teeth from the background. A sequence of filtering operations is performed using different Point Spread Functions (PSFs) with different direction in order to improve the segmentation performance and to reduce the effect of the bones, and teeth interfering. The fundamental sub-phases of filtering operation are: a) blurring the image by convolving it using 2D filters PSF that simulates a motion blur and specifies the length and angle of the blur, using different PSFs to filter the image in different direction; b) subtracting the output from the original image; c) applying global thresholding to get thresholded image; and d) masking the original image with the thresholded image by setting all zeros in the thresholded image to zeros in the original image.

In a connect component labeling phase, the connected pixels can be grouped in the thresholded image. The pixels of the binary image produced in the enhancement stage are grouped according to their connectivity and assigned labels that identify the different connected components. The outcome of the connected components stage may not represent one tooth, part of the tooth such as root or crown, more than one tooth, and bones.

Finally, in a refinement phase the unqualified connected components can be eliminated based on analyzing the geometry properties of each of the connected components. The connected components based on their geometric properties including area, position, and dimension and then eliminate the unqualified objects generated from teeth inferring and background noise.

Each filtering operation of local segmentation suppresses the bones and background at certain direction. This can be performed by 1) distorting the image using point spread function that simulates a motion distortion and specifies the length and angle of the distortion, and then 2) thresholding the image produced from subtraction of the distorted image form the original image, and finally 3) masking the original image with the thresholded image.

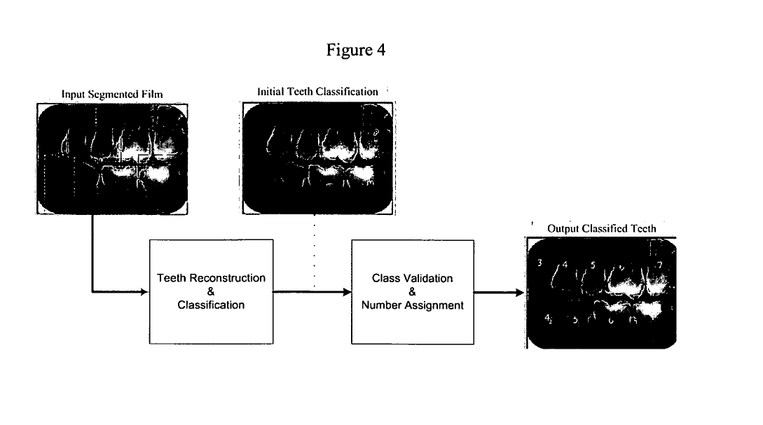

The final preprocessing sub-step can be the automatic classification of teeth into incisors, canines, premolars and molars and hence automatic construction of dental charts FIG. 4. In the first phase (Teeth reconstruction and Classification), a segmented tooth can be projected onto four image subspaces (or eigen-spaces) corresponding to the four teeth classes (incisors, canines, premolars, and molars); then using an intensity based classification scheme one may assign an initial class label for each segmented tooth. In the second phase (Class Validation and Number assignment), the neighborhood relations between the segmented teeth may be considered to validate and, if necessary correct, the initially assigned classes and hence to assign each tooth a number corresponding to its location in the dental chart. A dental chart is a data structure that associates each segmented tooth with a cell in a dental atlas corresponding to the 32 possible teeth of an adult. Automatic classification guides the logical pairing of reference and subject ROIs conformable for comparison. A method for automatic construction of dental charts using low computational-cost appearance-based features and string matching has been developed.

The key idea behind the initial step of classification in the teeth labeling approach is to establish four image subspaces corresponding to the four teeth classes (only molar and premolar classes in case of bitewing films), then to use the projections of a novel tooth onto these subspaces as basis for classification. With these image subspaces constructed, initial teeth classification is as follows:

A) An input tooth t_{q} is view-normalized to compensate for possible geometric variations that may cause significant differences between that tooth and the exemplar sets used for constructing the four subspaces.

B) The view-normalized input tooth t_{qr} is projected onto the four image subspaces. Hence, we obtain four coefficient sets ω_{I}, ω_{C}, ω_{P}, and ω_{M}, are obtained corresponding respectively to the projections of t_{qr} onto the incisors subspace, the canines subspace, the premolars subspace, and the molars subspace.

C) The obtained weight sets are used in conjunction with the sample mean of each of the four teeth classes to reconstruct the view-normalized tooth t_{qr} in the four image subspaces, thus obtaining the approximations T_{I}, T_{C}, T_{P}, and T_{M}.

D) t_{qr} and each of its four approximations are feed to classifier that calls out one of the four classes according to least energy discrepancy between the view normalized tooth and its four approximations, thus obtaining an initial class assignment for t_{qr}.

A second sub-phase is Class Validation and Number Assignment. As in most of the classification problems, the initial class labels assigned to each tooth, according to the least energy discrepancy rule, are prone to errors. However, a dental film usually shows a number of teeth, and because the assortment of teeth in a human mouth follows a specific pattern, teeth neighborhood rules can be relied upon to validate the detected sequence of teeth class labels. Sequences that do not conform to the reference pattern of possible sequences are corrected if possible. Finally, if the validated/corrected sequence is unique, it is assigned a number to each tooth corresponding to its position in its dental quadrant. This method for class validation is based on string matching. When validating bitewing sequences, the horizontal distance between teeth in the upper and lower jaws is taken into consideration. So taking:

X denote the 16 character reference string ‘MMMPPCIIIICPPMMM’.

S_{F}=sᵢ . . . sⱼ . . . sₙ such that, 1<n<16 and sⱼ [symbol] (‘I’, ‘C’, ‘P’, ‘M’), denote the sequence of the initially assigned labels of the segmented teeth of the radiographic film F.

The class validation problem is treated as a string-matching problem with error, where the user seeks to match the pattern S_{F} to the text X with the possibility of error in the former. Of all the possible changes, if a change is required due to impossibility of matching S_{F} to X without errors, seek S_{F′} to minimize the cost C (S_{F}→S_{F′}). Moreover, with bitewing views a user can detect, and if possible correct, instances where the resulting sequences of the upper and lower quadrants are inconsistent with one another, i.e. crisscrossed quadrants.

The automated dental system can further establish data communication between a client and database via a network to perform the above functions. The network may comprise, for example, the Internet, a local area network, a wide area network, or any other type of network as can be appreciated. The client comprises, for example, a computer system such as a laptop, desktop, or other type of computer system as can be appreciated. In this respect, the client includes a display device, a keyboard, and a mouse. In addition, the client may include other peripheral devices such as, for example, a keypad, touch pad, touch screen, microphone, scanner, joystick, or one or more push buttons, etc. The peripheral devices my also include indicator lights, speakers, printers, etc. The display device may be, for example, cathode ray tubes, liquid crystal display screens, gas plasma-based flat panel displays, or other types of display devices, etc. The client includes a processor circuit having a processor and a memory both of which are coupled to a local interface. In this respect, the client may comprise a computer system or other device with like capability.

The server may comprise, for example, a computer system having a processor circuit as can be appreciated by those with ordinary skill in the art. In this respect, the server includes the processor circuit having a processor and a memory, both of which are coupled to a local interface. The local interface may comprise, for example, a data bus with an accompanying control/address bus as can be appreciated. A number of software components are stored in the memories and are executable by the processors. In this respect, the term “executable” means a program file that is in a form that can ultimately be run by the processors. Examples of executable programs may be, for example, a compiled program that can be translated into machine code in a format that can be loaded into a random access portion of the memories and run by the processors, or source code that may be expressed in proper format such as object code that is capable of being loaded into random access portion of the memories and executed by the processors etc. An executable program may be stored in any portion or component of the memories and including, for example, random access memory, read-only memory, a hard drive, compact disk, floppy disk, or other memory components.

In this respect, the memories are defined herein as both volatile and nonvolatile memory and data storage components. Volatile components are those that do not retain data values upon loss of power. Nonvolatile components are those that retain data upon a loss of power. Thus, each of the memories may comprise, for example, random access memory, read-only memory, hard disk drives, floppy disks accessed via an associated floppy disk drive, compact discs accessed via a compact disc drive, magnetic tapes accessed via an appropriate tape drive, and/or other memory components. In addition, the RAM may comprise, for example, static random access memory, dynamic random access memory, or magnetic random access memory and other such devices. The ROM may comprise, for example, a programmable read-only memory, an erasable programmable read-only memory, an electrically erasable programmable read-only memory, or other like memory device.

The outcome of search and retrieval stage is the creation of potential match list (candidate list). This list is created by extracting high-level features (e.g. number and type of teeth,) from the preprocessed record and searching the DIR for reference records that possess high similarity to the entered high-level features. Candidates are the bearers of reference records with dental/non-dental features that are potentially similar to those possessed by the bearer of the subject record. Establishing a data communication between a client coupled to a server via a network and searching a dental records database via the data communication to create a candidate list may be implemented using any one of a number of programming languages such as, for example, Matlab, C++, or other programming languages.

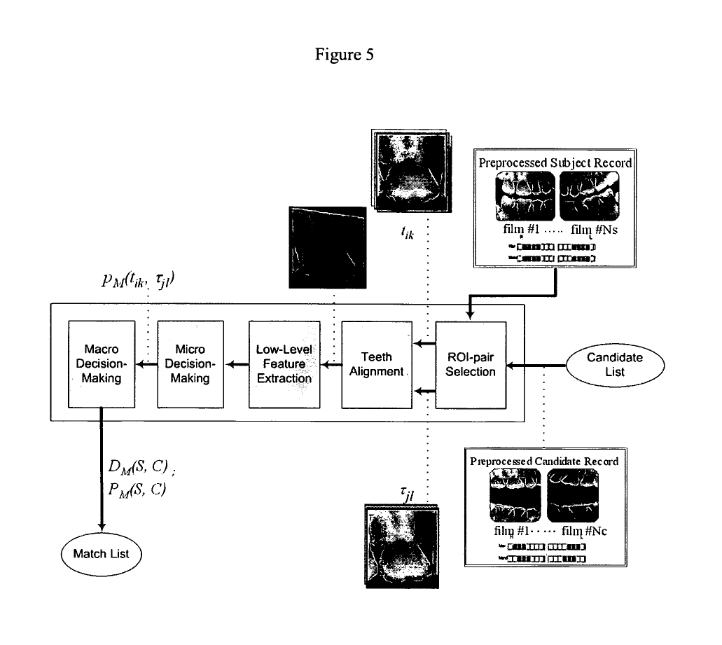

Comparing raw subject dental records to the candidate list to categorize potential matches may be comprised of image comparison steps to rank the candidate records, and according to the ranking scores those records are classified into matched, undetermined and unmatched lists. The image comparison step may be made up of 5 sub-steps: ROI selection, teeth alignment, low-level feature extraction, micro-decision making, and macro-decision making to create a match list, FIG. 5. In concept, image features range from pixel intensities (the lowest level image features) to semantic and content descriptors of images (the highest level of image features). In the verification stage, comparisons are performed between the dental records of a subject against those of candidates based on low-level image features. The low-level features are extracted from the segmented and aligned subject/reference teeth-pairs by convolution with filter kernels. In earlier work, a special neural network algorithm was developed by means of which the feature extraction filter kernels were obtained.

In ROI pair selection step, guided by the output of the automatic classification of teeth-sub-steps of the preprocessing step, a corresponding segmented teeth pair (regions of interest “ROI”) can be selected for subject and candidate records. Given a subject tooth view (tᵢₖ) and its reference counterpart (τⱼₗ), a region of interest alignment of the subject is performed to extract low-level image features from the aligned image pair, which are accordingly used to determine the probability of match between tᵢₖ and τⱼₗ (as depicted in FIG. 5). In the alignment sub-step, one may conduct pair-wise region of interest (ROI) alignment. Starting with a hypothesis that the two objects (ROI) are matched, the appropriate transformations that restore major geometric discrepancies between them may be applied. During region of interest (ROI) selection and alignment the teeth-pairs can be selected based on the dental charts of the reference and subject records to avoid illogical comparisons (e.g. molars are compared to molars but not to canines). The appropriate transformation that restores major geometric discrepancies between ROI-pair can be achieved by teeth alignment.

In the low-level feature extraction sub-step, a set of nonlinear filters to map the ROI in the corresponding feature spaces may be utilized. The low level feature extraction employs a set of nonlinear filters {ƒₖ: k=1, 2, . . . , n_{f}} to map an n x n pixel ROI to a set of m×m pixel images in the corresponding feature spaces {Z^{[k]}: k=1, 2, . . . , n_{f}}. In each of the n_{ƒ} spaces, the pixel values of feature images fall in the range (0, 1). A feature image (Z^{[k]}) can be thought of as the output layer of a grid of m×m artificial neurons. The receptive fields of neurons have some overlaps with those of neighboring neurons. These neurons share the weight set W^{[k]}, the bias tₖ, and the binary sigmoid activation function ƒ. This arrangement can also be thought of as a single neuron whose receptive field changes to cover the entire n x n normalized and compressed ROI. Thus, the features to be used for matching are not specified explicitly; rather a set of exemplar image ROI pairs, both matched and unmatched (or positive and negative examples) may be presented to the system. The filter parameters can be adapted, and consequently the features changed, so that the difference between features is reasonably small for matched exemplar pairs and the difference between features is reasonably large for unmatched exemplar pairs.

As dental records may provide multiple views of a tooth, a mechanism for fusing matching probabilities due to multiple views of a tooth was devised. The result is a single match score (or probability) between a subject tooth ti and its reference counterpart τⱼ. thus hardening this match probability to a micro decision using two decision thresholds. Because dental records often comprise yet another level of multiplicity; i.e. teeth multiplicity, another level of fusion is used to consolidate the multiple micro decisions to a macro decision, or a case-to-case match decision. In this micro-decision sub-step, a Bayesian classification layer that computes the posterior probability of match between a pair of ROI's using the differences between spatially corresponding features of the ROI-pair can be used. This is called micro-decision making because a dental record is usually comprised of multiple films that may show more than a single view of a given tooth. Therefore, the process of determining the match status of a subject/reference tooth-pair is based on comparison of multiple views of this tooth-pair.

Finally in the macro-decision sub-step, the micro-decisions may be combined into a macro-decision that determines the match status of the subject/candidate record-pair and accordingly whether the candidate record should be placed on the match list. Because a dental record usually comprises multiple films that may show more than a single view of a given tooth this view multiplicity is exploited in reaching a more robust decision about the match status of a subject/reference tooth-pair. This determination of the match status of a subject/reference tooth-pair based upon the comparison of multiple views of the tooth-pair is the micro-decision making step of ranking. There can be up to 32 micro-decisions in a fully developed adult, which are combined into a macro-decision that determines the match status of the subject/candidate record-pair and accordingly whether the candidate record should be placed on the list. The outcome of the comparison is a short match list ranked according to the probability of match between the subject record and each qualifying candidate record. A ranking score to sort the match list can also be provided. In macro decision-making we fuse decisions (not match scores) and hence the only fair and suitable fusion scheme is the majority-voting rule. With N micro-decisions {d_{M}}, the majority voting rule reads:

$${D}_{M} ( S , R ) = {Ω}_{j} \vert j = {arg}_{v} max \{ {N}_{v} \} ; v ∈ \{ 1 , 2 , 3 \} ,$$

S: subject, R: reference, Ωⱼ∈{‘Matched’, ‘Unmatched’, ‘Undetermined’}. Where N₁, N₂, and N₃ respectively indicate the number of instances where d_{M}=‘Matched’, d_{M}=‘Unmatched’, and d_{M}=‘Undetermined’ such that N=N₁+N₂+N₃. N₁, N₂, and N₃ is used to compute a rank score ρ_{M}(S, R), which helps us in sorting the match list. The rank score ρ_{M}(S, R) is thought of as function g(N₁, N₂, N₃) with the following desirable characteristics. First, g is non-decreasing in both N₁ and N₃. So, as either the number of micro matches and/or the number of undetermined micro decisions increases, ρ_{M}(S, R) should not decrease. Next, g is non-increasing in N₂. Conversely, as the number of the micro mismatches increases, ρ_{M}(S, R) should not increase. Then, g(32, 0, 0)=1. As ultimately for a subject/reference pair that has 32 matched teeth (the maximum number of teeth is a normal adult), this reference record should be examined before any others that appear in the match list. In addition, g(0, N₂, 0)=0. As the function g should be grounded for N₁=N₃=0. Moreover, this corresponds to a record that will not be placed in the match list to begin with. Finally, g(0, 0, 32)=½ (by rational choice). One possibility for the ranking function g is

$${g}_{1} ( {N}_{1} , {N}_{2} , {N}_{3} ) = \frac{{( \sqrt{2} {N}_{1} + {N}_{3} )}^{2}}{64 ( {N}_{1} + {N}_{2} + {N}_{3} )} .$$

Thus a ranking score is also provided to sort the match list.

Potential matches may be manually inspected for a final determination. One skilled in the art may compare the enhanced subject record with the records of the candidate list. One skilled in the art may be a forensic odontologist. The potential matches may be taken from the category of match list if the potential matches are categorized as match list, reject list, and undetermined. In addition, a match list may be further processed by adding a ranking score to possible matches in the match list automatically in order to produce a match list with probably matches ranked in order of probability.

These terms and specifications, including the examples, serve to describe the invention by example and not to limit the invention. It is expected that others will perceive differences, which, while differing from the forgoing, do not depart from the scope of the invention herein described and claimed. In particular, any of the function elements described herein may be replaced by any other known element having an equivalent function.

What is claimed is:

1. An automated dental identification system comprising
establishing and enhancing raw subject dental records and extracting high level features;
establishing data communication between a client coupled to a server via a network;
searching a dental records database via said data communication and creating a candidate list; and
comparing a subject dental record to the candidate list to categorize potential matches.

2. The automated dental identification system of claim 1 wherein said potential matches are placed in the categories of match list, reject list, and undetermined for said manual inspection.

3. The automated dental identification system of claim 1 further comprising manually inspecting potential matches for a final determination wherein said manual inspection is performed by a forensic deontologist.

4. The automated dental identification system of claim 1 said establishing and enhancing raw subject dental records further comprising record preprocessing wherein said record preprocessing comprises record cropping, film-enhancement, film type detection, teeth segmentation, and teeth labeling.

5. The automated dental identification system of claim 1 said searching dental records and creating a candidate list further comprising potential matches searching wherein said potential matches search comprises high-level feature extraction, archiving, and retrieval.

6. The automated dental identification system of claim 2 wherein said match list has a ranking score for possible matches.

7. The automated dental identification system of claim 1 wherein said comparing subject dental records to the candidate list further comprises teeth alignment, low-level feature extraction, and decision making.

8. The automated dental identification system of claim 1 wherein said dental records database is the NDIR, or a database uploaded for a specific event such as a plane crash.

9. The automated dental identification system of claim 1 wherein said searching a dental records database can further include searching one or more of a specific age, gender, race, or blood type.

10. An automatic record preprocessing comprising record cropping, film enhancement, film type detection, teeth segmentation, and teeth labeling.

11. The automatic record preprocessing of claim 10 wherein said cropping further comprises a background extraction of the image, a corner type classification and cropping based on either arch detection or factor analysis, and post processing to eliminate non-film objects.

12. The automatic record preprocessing of claim 10 wherein said film type detection classifies the film as either bitewing or periapical.

13. The automatic record preprocessing of claim 12 wherein said periapical can be further classified as either upper or lower periapical.

14. The automatic record preprocessing of claim 10 wherein said teeth segmentation further comprises enhancement, connected components labeling, and refinement.

15. The automatic record preprocessing of claim 10 wherein said teeth labeling further comprises the automatic classification of teeth into one of incisor, canine, premolar, or molar.

16. An automated dental records search comprising extracting high-level features from a preprocessed record, searching the DIR database for reference records possessing a high similarity to the preprocessed records, and creating a candidate list of similar records.

17. The automated dental records search of claim 16 further comprising the use of non-dental features to reduce records searched.

18. The automated dental records search of claim 17 wherein said non-dental features are one or more of a specific age, gender, race, or blood type.

19. The automated dental records search of claim 17 further comprising ranking the candidate records to create the match list.

20. The automated dental records search of claim 19 wherein the ranking scores place the records into one of matched, undetermined, and unmatched to create the match list.
